(19) United States
(12) Patent Application Publication
(10) Pub. No.: US 2016/0062640 A1
(43) Pub. Date: Mar. 3, 2016

(54) ELECTRONIC DEVICE FOR BROWSING DATA AND METHOD THEREOF

(71) Applicant: Chiun Mai Communication Systems, Inc., New Taipei (TW)

(72) Inventor: WEI-LI LU, New Taipei (TW)

(21) Appl. No.: 14/841,732

(22) Filed: Sep. 1, 2015

(30) Foreign Application Priority Data
Sep. 1, 2014 (CN) 201410440174.X

(51) Int. Cl. G06F 3/0488; G06F 3/0484; G06F 3/0483; G06F 3/0481

(52) U.S. Cl. CPC G06F 3/04883; G06F 3/0481; G06F 3/04847; G06F 3/0483; G06F 3/04845

(57) ABSTRACT

A method for browsing data on an electronic device includes detecting touch input on a touch display of the electronic device and determining whether a contact point of the touch input on the touch display corresponds to a designated window displayed on the touch display. When the contact point does not correspond to the designated window, a designated window displaying a corresponding interface therein is creatable at the contact point when a pressure value of the touch input is greater than or equal to a first threshold pressure value. When the contact point corresponds to the designated window, a size of the designated window is adjusted according to a pressure value of the touch input at the contact point. The designated window is closed when the pressure value of the touch input is greater than or equal to a second threshold pressure value.

### FIELD

The present disclosure relates to data browsing, and more particularly to an electronic device for browsing a plurality of interfaces simultaneously on a touch display.

### BACKGROUND

Generally, data can be browsed by various different means on an electronic device, including, for example, using webpages, documents, and applications of the electronic device. When browsing data in more than one application, for example, a user may need to switch between the different applications.

### BRIEF DESCRIPTION OF THE DRAWINGS

Implementations of the present technology will now be described, by way of example only, with reference to the attached figures.

FIG. 1 is a block diagram of an embodiment of an electronic device implementing a data managing system.

FIG. 2 is a diagrammatic view of an embodiment of a plurality of buttons for creating a designated window on a display of the electronic device.

FIG. 3 is a diagrammatic view of an embodiment of a designated window displayed on the display.

FIG. 4 is a flowchart of an embodiment of a method for browsing data on an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

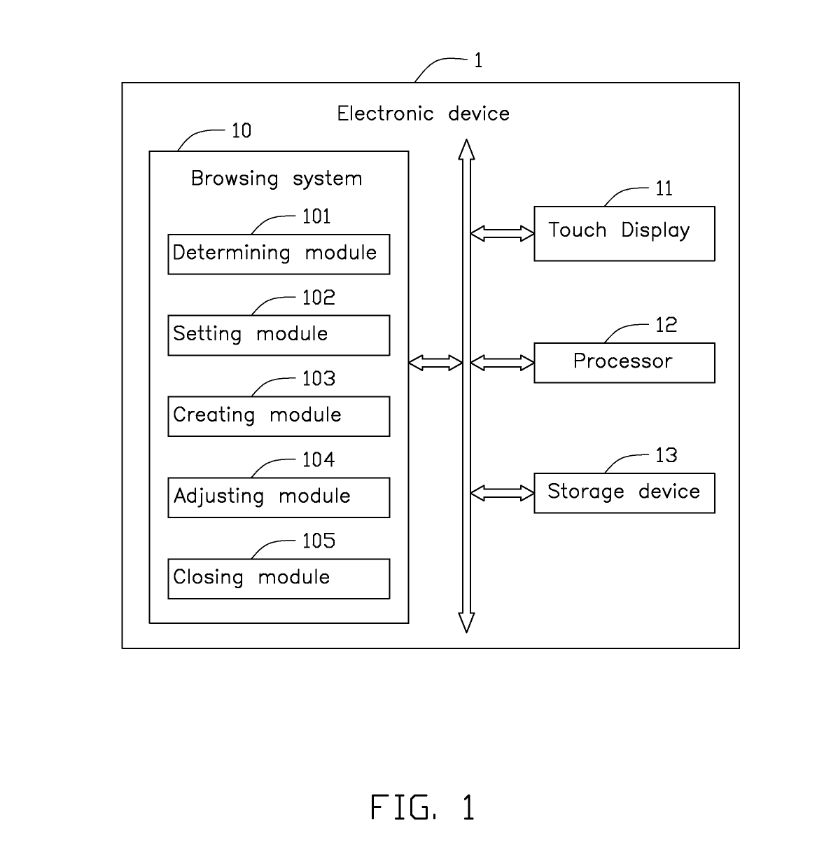

FIG. 1 illustrates an exemplary embodiment of an electronic device 1 implementing a browsing system 10 for browsing data. The electronic device 1 can include a touch display 11, a processor 12, and a storage device 13. The touch display 11 can receive touch input thereon and can sense a pressure value of the touch input. In at least one embodiment, the touch display 11 is made of carbon nanotubes for sensing a pressure value of the touch input.

The browsing system 10 can include a plurality of modules, such as a determining module 101, a setting module 102, a creating module 103, an adjusting module 104, and a closing module 105. The modules 101-105 can include one or more software programs in the form of computerized codes stored in the storage device 13. The computerized codes can include instructions executed by the processor 12 to provide functions for the modules 101-105.

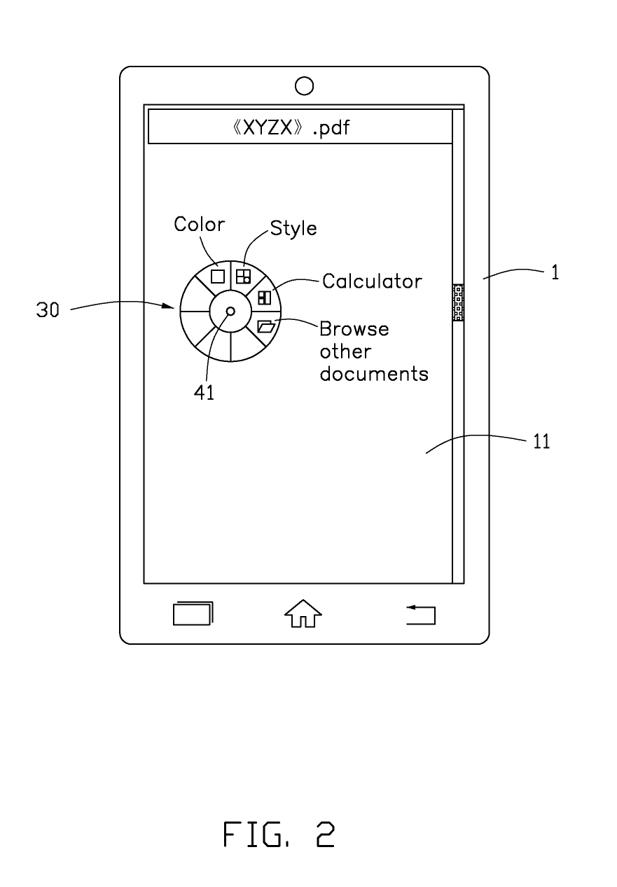

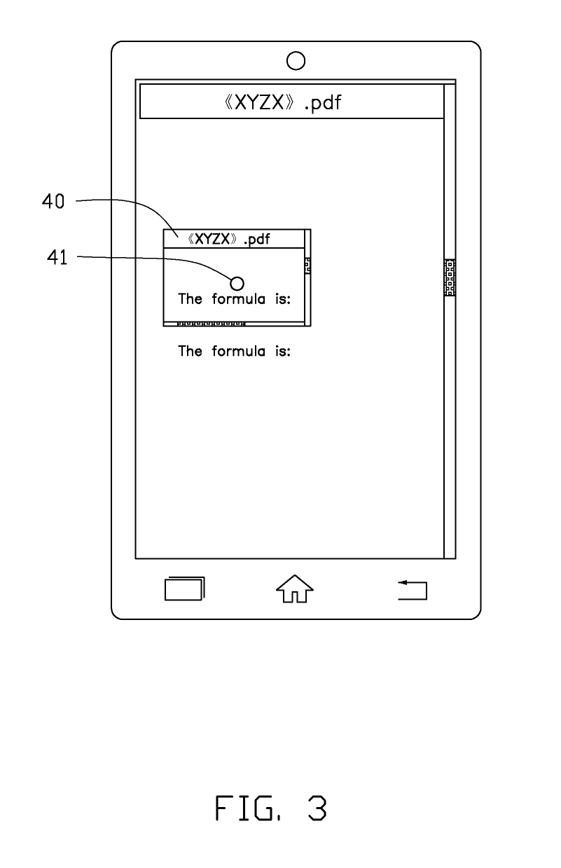

The determining module 110 can determine whether a contact point 41 (shown in FIG. 2) of touch input applied on the touch display 11 corresponds to a designated window 40 (shown in FIG. 3) displayed on the touch display 11. When there is no designated window 40 displayed on the touch display 11, then the contact point 41 does not correspond to the designated window 40 by default. When the contact point 41 of the touch input does not correspond to the designated window 40, the determining module 110 can determine whether a pressure value of the touch input is greater than or equal to a first threshold value. In at least one embodiment, a pressure value range detectable by the determining module 110 is a normalized pressure value range having a range from 0.0 to 1.0. 0.0 represents a least pressure value detectable by the determining module 110, and 1.0 represents a greatest pressure value detectable by the determining module 110. In at least one embodiment, the first threshold pressure value is equal to 0.4 in the normalized pressure value range.

As illustrated in FIG. 2, the touch display 11 is currently displaying an interface of a document called, “ [symbol] xyzx [symbol] .pdf”. When the pressure value of the touch input is greater than or equal to the first threshold pressure value, the setting module 102 can display a setting interface 30 at the contact point 41. In at least one embodiment, the setting module 102 centers the setting interface 30 about the contact point 41. The setting interface 30 can receive user input to set a plurality of characteristics of the designated window 40. In at least one embodiment, the setting interface 30 can include a plurality of buttons (not labeled) for receiving the user input. For example, the plurality of buttons can include a button to change a color of the designated window 40, a button to change a style of the designated window 40, a button to change a transparency of the designated window 40, and the like. In at least one embodiment, the setting interface can include at least one button for being selected to open an interface to be displayed in the designated window. For example, one of the buttons can be selected to open an interface of an application, such as a calculator, of the electronic device 1, and another button can be selected to open an interface of another document. When none of the buttons to open another interface are selected, then the designated window 40 can display the interface currently displayed on the touch display 11 by default (i.e., the document “ [symbol] xyzx [symbol] .pdf”). The designated window 40 can be created by applying touch input to a predetermined point of the touch display 11, such as a center of the setting interface 30 or any point of the display 11 outside of the setting interface 30. The touch input to the predetermined point of the touch display 11 can generate a confirmation signal and transmit the confirmation signal to the creating module 103, and the creating module 103 can create the designated window 40 in response to the confirmation signal. In another embodiment, the confirmation signal can be generated by pressing a physical key of the electronic device 1, applying a predetermined touch gesture on the touch display 11, or the like.

As illustrated in FIG. 3, the creating module 103 can create the designated window 40 according to the characteristics set by the setting module 102 in response to the confirmation signal. In at least one embodiment, the creating module 103 centers the designated window 40 about the contact point 41. In at least one embodiment, the designated window 40 is a window displayed on the touch display to assist in browsing a corresponding interface. As illustrated in FIG. 3, the designated window 40 displays the interface currently being displayed on the touch display 11. In at least one embodiment, the creating module 103 can obtain the interface currently being displayed on the touch display 11 for the designated window 40 to display according to application programming interface (API) functions of the interface currently being displayed. Portions of the interface currently being displayed around the contact point can be displayed in the designated window 40. The other portions of the interface currently being displayed can be browsed in the independent window 40 independently from the interface currently being displayed on the touch display 11 by touch input, such as sliding touch gestures applied on the interface displayed in the designated window 40. Thus, a user can browse different portions of the document “ [symbol] xyzx [symbol] ” simultaneously. In at least one embodiment, the designated window 40 can be moved do different areas of the touch display 11 by touch input, such as a sliding touch gesture on a header portion of the designated window 40.

When the determining module 101 determines that the contact point 41 corresponds to the designated window 40, the adjusting module 104 can adjust a size of the designated window 40. In at least one embodiment, the size of the designated window 40 is increased as the pressure value of the touch input increases.

The closing module 105 can determine whether the pressure value of the touch input at the contact point 41 corresponding to the designated window is greater than or equal to a second threshold pressure value. In at least one embodiment, the second threshold pressure value is equal to 0.9. When the pressure value of the touch input is greater than or equal to the second threshold pressure value, the closing module 105 closes the designated window 40.

In another embodiment, a plurality of designated windows 40 displaying corresponding interfaces can be created on the touch display 11. Each designated window 40 can be created as described above.

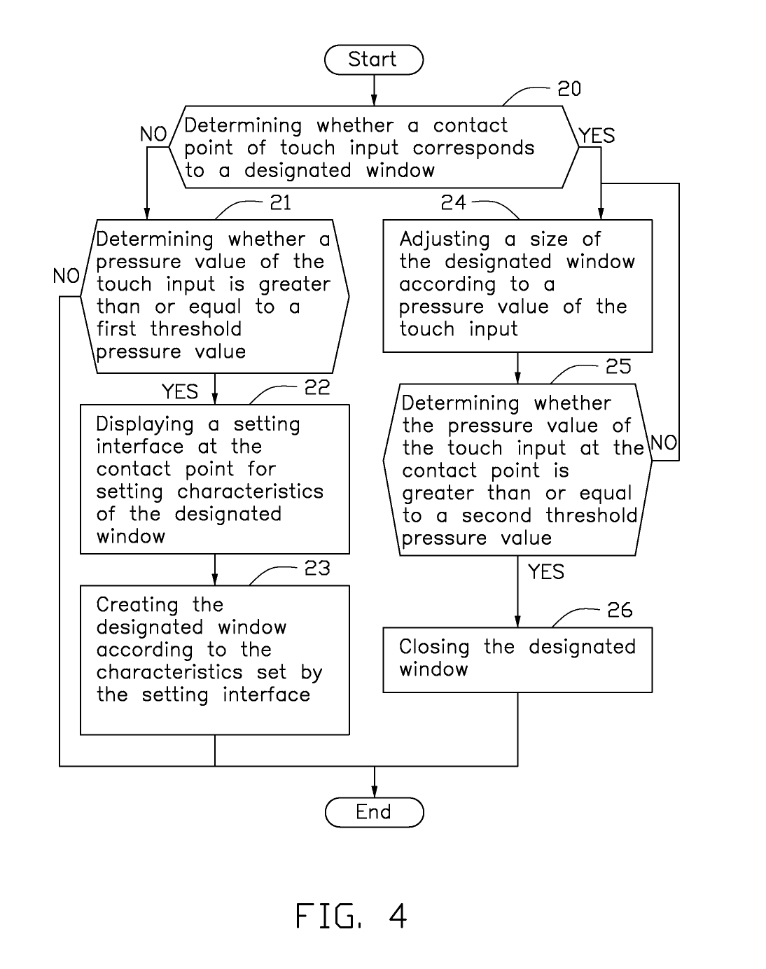

FIG. 4 illustrates a flowchart of an embodiment of a method for browsing data on an electronic device. The example method is provided by way of example, as there are a variety of ways to carry out the method. The method described below can be carried out using the configurations illustrated in FIGS. 1-3, for example, and various elements of these figures are referenced in explaining the example method. Each block shown in FIG. 4 represents one or more processes, methods, or subroutines carried out in the example method. Furthermore, the illustrated order of blocks is by example only, and the order of the blocks can be changed. Additional blocks may be added or fewer blocks may be utilized, without departing from this disclosure. The example method can begin at block 20.

At block 20, the electronic device can determine whether a contact point of touch input applied on a touch display of the electronic device corresponds to a designated window displayed on the touch display. When there is no designated window displayed on the touch display, then the contact point does not correspond to the designated window by default. When the contact point does not correspond to the designated window, block 21 is implemented. When the contact point corresponds to the designated window, block 24 is implemented.

At block 21, the electronic device can determine whether a pressure value of the touch input is greater than or equal to a first threshold pressure value. In at least one embodiment, a pressure value range detectable by the electronic device is a normalized pressure value range having a range from 0.0 to 1.0. 0.0 represents a least pressure value detectable by the electronic device, and 1.0 represents a greatest pressure value detectable by the electronic device. In at least one embodiment, the first threshold pressure value is equal to 0.4. When the pressure value is not greater than or equal to the first threshold pressure value, the method ends. When the pressure value is greater than or equal to the first threshold pressure value, block 22 is implemented.

At block 22, the electronic device can display a setting interface at the contact point for setting characteristics of the designated window. In at least one embodiment, the setting interface is centered about the contact point. The setting interface can receive user input to set characteristics of the designated window. In at least one embodiment, the setting interface can include a plurality of buttons for receiving the user input. For example, the plurality of buttons can include a button to change a color of the designated window, a button to change a style of the designated window, a button to change a transparency of the designated window, and the like. In at least one embodiment, the setting interface can include at least one button for being selected to open an interface to be displayed in the designated window. For example, one of the buttons can be selected to open an interface of an application, such as a calculator, of the electronic device, and another button can be selected to open an interface of another document. When none of the buttons to open another interface are selected, then the designated window can display the interface currently displayed on the touch display by default.

At block 23, the electronic device can create the designated window according to the characteristics set by the plurality of buttons. The designated window can be created by applying touch input to a predetermined point of the touch display, such as a center of the plurality of buttons or any point of the touch display outside of the plurality of buttons. The touch input to the predetermined point of the touch display can generate a confirmation signal and send the confirmation signal to the creating module for creating the designated window. In other embodiments, the confirmation signal can be generated by pressing a physical key of the electronic device, applying a predetermined touch gesture on the touch display, or the like. In at least one embodiment, the interface currently being displayed on the touch display can be obtained according to application programming interface (API) functions of the interface and be displayed in the designated window. Portions of the interface currently being displayed around the contact point can be displayed in the designated window. The other portions of the interface currently being displayed can be browsed in the current window independently from the interface currently being displayed on the touch display by touch input, such as sliding touch gestures applied on the interface displayed in the designated window. In at least one embodiment, the designated window can be moved do different areas of the touch display by touch input, such as a sliding touch gesture on a header portion of the designated window.

At block 24, the electronic device adjusts a size of the designated window according to a pressure value of the touch input. In at least one embodiment, the size of the designated window is increased as the pressure value of the touch input is increased.

At block 25, the electronic device determines whether the pressure value of the touch input is greater than or equal to a second threshold pressure value. In at least one embodiment, the second threshold pressure value is equal to 0.9. When the pressure value of the touch input is not greater than or equal to the second threshold pressure value, block 24 is repeated. When the pressure value of the touch input is greater than or equal to the second threshold pressure value, block 26 is implemented.

At block 26, the designated window is closed.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for browsing data on an electronic device, the method comprising:
detecting, by the electronic device, touch input on a touch display of the electronic device and determining whether a contact point of the touch input on the touch display corresponds to a designated window displayable on the touch display;
determining, by the electronic device, whether a pressure value of the touch input at the contact point is greater than or equal to a first threshold pressure value;
displaying, by the electronic device, a setting interface at the contact point when the pressure value of the touch input is greater than or equal to the first threshold pressure value, wherein the setting interface is configured to receive user input to set a plurality of characteristics of the designated window; and
creating, by the electronic device at the contact point, the designated window in response to the user input on the plurality of buttons.

2. The method as in claim 1, wherein the setting interface includes at least one button for being selected to open an interface to be displayed in the designated window.

3. The method as in claim 1, wherein the interface displayed in the designated window is an interface currently displayed on the touch display or another interface currently not displayed on the touch display.

4. The method as in claim 1, wherein the interface displayed in the designated window is navigable independently from the interface currently displayed on the touch display.

5. The method as in claim 1, wherein when the contact point corresponds to the designated window:
the electronic device adjusts a size of the designated window according to the pressure value of the touch input at the contact point;
the electronic device determines whether the pressure value of the touch input is greater than or equal to a second threshold pressure value; and
the electronic device closes the designated window when the pressure value of the touch input is greater than or equal to the second threshold pressure value.

6. The method as in claim 1, wherein the designated window is movable along the touch display by touch input.

7. The method as in claim 1, wherein the size of the designated window is increased as the pressure value of the touch input on the designated window increases.

8. The method as in claim 1, wherein the designated window is created in response to a confirmation signal corresponding to user input on the electronic device.

9. The method as in claim 1, wherein:
a plurality of designated windows is creatable by applying a plurality of touch inputs to a plurality of contact points of the touch display;
each designated window is created at the corresponding contact point when a pressure value of the touch input is greater than or equal to the first threshold value to set the characteristics of the designated window;
each designated window is able to display the interface currently displayed on the touch display or display another interface currently not displayed on the touch display; and
the plurality of designated windows displaying the corresponding interfaces therein is displayed simultaneously and the corresponding interfaces are navigable independently from the interface currently displayed on the touch display.

10. An electronic device comprising a touch display and implementing a browsing system for browsing data, the browsing system comprising a plurality of modules, the plurality of modules comprising:
a determining module configured to determine whether a contact point of touch input applied on the touch display corresponds to a designated window displayable on the touch display, and determine whether a pressure value of the touch input at the contact point is greater than or equal to a first threshold pressure value;
a setting module configured to display a setting interface at the contact point when the pressure value of the touch input is greater than or equal to the first threshold pressure value, wherein the setting interface is configured to receive user input to set a plurality of characteristics of the designated window; and
a creating module configured to create the designated window at the contact point according to the plurality of characteristics.

11. The electronic device as in claim 10, wherein the setting interface includes at least one button for being selected to open an interface to be displayed in the designated window.

12. The electronic device as in claim 10, wherein the interface displayed in the designated window is an interface currently displayed on the touch display or another interface currently not displayed on the touch display.

13. The electronic device as in claim 10, wherein the interface displayed in the designated window is navigable independently from the interface currently displayed on the touch display.

14. The electronic device as in claim 10, wherein the designated window is created by the creating module in response to a confirmation signal corresponding to user input on the electronic device.

15. The electronic device as in claim 14, wherein the browsing system further comprises:
an adjusting module configured to adjust, when the determining module determines that the contact point on the touch display corresponds to the designated window, a size of the designated window according to the pressure value of the touch input; and
a closing module configured to determine whether the pressure value of the touch input at the contact point corresponding to the designated window is greater than or equal to a second threshold pressure value, and close the designated window when the pressure value of the touch input is greater than or equal to the second threshold pressure value.

16. The electronic device as in claim 15 comprising:
a storage device configured to store a plurality of instructions of the plurality of modules of the browsing system; and
a processor configured to execute the plurality of instructions of the plurality of modules of the browsing system.

17. The electronic device as in claim 13, wherein the designated window is movable along the touch display by touch input.

18. The electronic device as in claim 15, wherein the size of the designated window is increased as the pressure value of the touch input on the designated window increases.

19. The electronic device as in claim 15, wherein:
a plurality of designated windows is creatable by applying a plurality of touch inputs to a plurality of contact points of the touch display;
the setting module displays the setting interface at each corresponding contact point when the contact point does not correspond to any designated window and when a pressure value of the touch input is greater than or equal to the first threshold value;
the creating module creates the corresponding designated window at the corresponding contact point according to the corresponding characteristics set by the setting module;
each designated window is able to display the interface currently displayed on the touch display or display another interface currently not displayed on the touch display; and
all of the plurality of designated windows displaying the corresponding interfaces therein are displayed simultaneously, and the corresponding interfaces are navigable independently from the interface currently displayed on the touch display.
